(19) United States
(12) Patent Application Publication
(10) Pub. No.: US 2026/0168556 A1
(43) Pub. Date: Jun. 18, 2026

(54) Shock absorber

(71) Applicant: Petro Nepyivoda, Edmonton (CA)

(72) Inventor: Petro Nepyivoda, Edmonton (CA)

(21) Appl. No.: 19/124,858

(22) PCT Filed: Apr. 25, 2023
(86) PCT No.: PCT/IB2023/054238

§ 371 Date: Apr. 26, 2025

(30) Foreign Application Priority Data
Jan. 19, 2023 (UA) A 2023 00191

(51) Int. Cl. F16F 9/32

(52) U.S. Cl. CPC F16F 9/3235; F16F 9/3214

(57) ABSTRACT

This invention relates to vehicle shock absorbers. This shock absorber comprises an oil-filled cylinder internally tapered from its middle to its ends, a toroidal piston with a central valve, and a hollow rod. The hollow rod contains a floating piston inside for separating the oil from air, and a valve at the end for air throttling. The piston forms a variable gap with the cylinder, enabling position-sensitive oil throttling. The throttlings through the valves and variable gap generate damping forces that effectively reduce oscillations, vibrations, and shocks.

### DESCRIPTION OF THE INVENTION

The present invention relates to mechanical engineering and pertains to devices designed to mitigate oscillations, vibrations, and shocks in vehicles. Telescopic shock absorbers commonly used in vehicles have a significant drawback: their damping action is not coordinated with vehicles's sprung mass and its positions during oscillations, which leads to excessive oscillations, vibrations and shocks.

The prior art related to this invention includes a single-tube shock absorber described in patent U.S. Pat. No. 2,774,446A, dated Dec. 18, 1956, which lacks the capability for variable damping. The most closely related prior art is patent U.S. Pat. No. 4,405,119A, issued on Sep. 20, 1983, in which a hydropneumatic shock absorber comprises a hollow rod with a pneumatic spring formed at its attachment end, a piston fixed to the hollow rod and slidably installed in a cylinder, mounted on a guide rod centrally fixed to the bottom of the cylinder. The design also includes two throttle valves integrated into the piston and throttling grooves located in the lower sections of both the cylinder and the guide rod. The disadvantage of this hydropneumatic shock absorber is that its damping force is not gradually variable.

The purpose of the present invention is to reduce vehicle oscillations, vibrations, and shocks by producing a position-sensitive, gradually varying damping force.

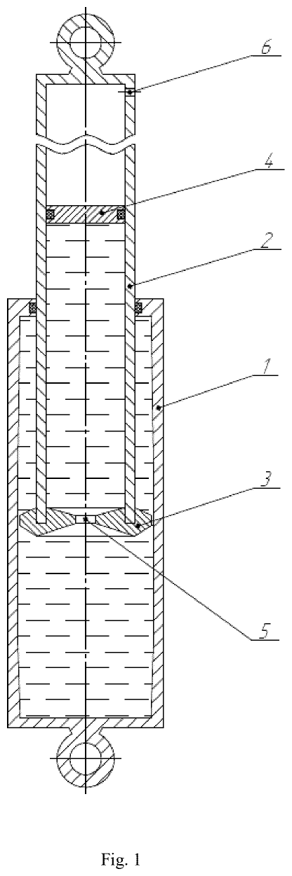

As shown in the FIG. 1, the shock absorber comprises a cylinder 1 filled with hydraulic oil, a hollow rod 2 that is seal-mounted movably in the cylinder 1, a piston 3 attached to the hollow rod 2 inside the cylinder 1. The cylinder 1 has a bottom with a mount and the hollow rod 2 has a mount at its end outside the cylinder 1. The piston 3 has a valve 5 in its center, forms an annular gap with the cylinder 1 and is configured as a toroid with a polygonal cross-section, the frontal portion of which is a sharp circular edge with a diameter equal to the outer diameter of the hollow rod 2, thereby, during the piston's 3 movement, enabling the hydraulic oil to be divided into two throttled flows to generate damping forces: one through the valve 5 and the other through the annular gap between the piston 3 and the cylinder 1.

The surface of the piston 3 is a toroid with a polygonal cross-section, which is generated by rotating a polygon about an axis lying within its plane but outside the polygon itself. This surface comprises conical and cylindrical sections, formed by the rotation of the polygon's sides, and sharp circular edges formed by the rotation of its vertices.

As shown in the FIG. 1, the piston 3 features a frontal sharp circular edge, front inner and outer conical surfaces, a middle outer cylindrical surface bordering the inner surface of the cylinder 1 through the annular gap, a middle inner cylindrical surface in the center, and rear inner and outer conical surfaces that align with the corresponding inner and outer surfaces of the hollow rod 2 at the point where the piston 3 is attached to the hollow rod 2.

The diameter of the frontal sharp circular edge of the piston 3 matches the outer diameter of the hollow rod 2, which ensures that the outer annular portion of the hydraulic oil, displaced by the piston 3 during its movement into the cylinder 1, equals the volume released between the hollow rod 2 and the cylinder 1, where this annular portion of the hydraulic oil flows through the annular gap. This facilitates the creation of two distinct flows of the hydraulic oil with minimal turbulence, maintaining the alignment of the cylinder 1 with the piston 3 during its movement and stable operation of the shock absorber.

The cylinder 1 is internally configured to be gradually narrowed from its middle portion to its ends, thereby, during the piston's 3 movement, enabling gradual change of the annular gap between the cylinder 1 and the piston 3 for gradual change of the hydraulic oil throttling through this annular gap. The narrowed inner surface of the cylinder 1, combined with the conical surfaces of the piston 3, enables stable operation of the shock absorber, ensuring minimal turbulence of the hydraulic oil flows.

The hollow rod 2 is equipped with a floating piston 4 to separate the hydraulic oil from air, and a valve 6 is mounted at its end, outside the cylinder 1, thereby enabling air throttling to create a damping force.

The shock absorber operates in the following way: in the compression phase, the piston 3, together with the hollow rod 2, moves deeper into the cylinder 1, dividing the hydraulic oil into two flows: one is throttled through the valve 5 inside the hollow rod 2, and the other flow is throttled through the annular gap between the piston 3 and the cylinder 1 into the space between the hollow rod 2 and the cylinder 1.

The annular gap gradually increases toward the middle of the cylinder 1, easing the hydraulic oil flow. This reduces the throttling and, accordingly, the damping force. After passing the middle portion of the cylinder 1, the annular gap begins to gradually decrease, increasing the resistance to the hydraulic oil flow. As a result, the throttling and damping force gradually increase.

When the piston 3 approaches the bottom of the cylinder 1, the damping force gradually reaches its maximum value, ensuring a smooth stop for the piston 3. Simultaneously, the portion of the hydraulic oil, throttled into the hollow rod 2 through the valve 5, creates an additional damping force and moves the floating piston 4, compressing the air in the space between the floating piston 4 and the valve 6. The compressed air flows out, throttled through the valve 6, thereby creating a damping force.

During the rebound phase, the hydraulic oil is throttled from the space between the hollow rod 2 and the cylinder 1 through the annular gap between the cylinder 1 and the piston 3, creating a damping force which decreases to the middle position of the piston 3, and then increases as the piston 3 approaches its uppermost position, where the piston 3 smoothly stops.

Simultaneously, the hydraulic oil inside the hollow rod 2 is throttled into the cylinder 1 through the valve 5, creating an additional damping force as the hollow rod 2, together with the piston 3, is being pulled out of the cylinder 1. At the same time, the floating piston 4 moves downward toward the piston 3, increasing the volume between the floating piston 4 and the valve 6. The air pressure inside the hollow rod 2 continues to rise briefly after the compression phase ends, until it equalizes with the air pressure outside the valve 6. Subsequently, the air pressure decreases as the volume expands due to the movement of the floating piston 4 toward the piston 3. This movement causes air throttling through the valve 6 into the hollow rod 2, thereby creating a corresponding damping force.

The technical result of the claimed invention is the minimization of oscillations, vibrations, and shocks in vehicles during movement. This is achieved through the position-sensitive damping created by the hydraulic oil throttling through the variable annular gap, additional damping force resulting from throttling by the valve 5, and the air damping resulting from the air throttling. This combination of damping forces of the shock absorber provides effective damping of oscillations and smooth driving of vehicles both with minor and significant road irregularities.

1. A shock absorber comprising a cylinder (1) filled with hydraulic oil, a hollow rod (2) movably seal-mounted in the cylinder (1), a piston (3) attached to the hollow rod (2) inside the cylinder (1), wherein the piston (3) has a valve (5) in its center, forms an annular gap with the cylinder (1), and is configured as a toroid with a polygonal cross-section, the frontal portion of which is a sharp circular edge with a diameter equal to the outer diameter of the hollow rod (2), thereby, during the piston's (3) movement, enabling the hydraulic oil to be divided into two throttled flows to create damping forces: one through the valve (5) and the other through the annular gap between the piston (3) and the cylinder (1); the cylinder (1) is internally configured to be gradually narrowed from its middle portion to its ends, thereby, during the piston's (3) movement, enabling gradual change of the annular gap between the cylinder (1) and the piston (3) for gradual change of the hydraulic oil throttling through this annular gap; the hollow rod (2) inside is equipped with a floating piston (4) to separate the hydraulic oil from air, and a valve (6) is mounted at its end, thereby enabling air throttling to create a damping force.
